(19) United States
(12) Patent Application Publication
(10) Pub. No.: US 2008/0248386 A1
(43) Pub. Date: Oct. 9, 2008

(54) ELECTRODES WITH RAISED PATTERNS

(76) Inventors: Mark N. Obrovac, St. Paul, MN (US); Leif Christensen, St. Paul, MN (US); Douglas C. Magnuson, Woodbury, MN (US)

Correspondence Address: 3M INNOVATIVE PROPERTIES COMPANY, PO BOX 33427, ST. PAUL, MN, 55133-3427, US

(21) Appl. No.: 11/696,979

(22) Filed: Apr. 5, 2007

(51) Int. Cl. H01M 4/02; H01M 4/04

(52) U.S. Cl. 429/209; 205/50

(57) ABSTRACT

Provided is an electrode for an electrochemical cell that includes a current collector, and an active material in electrical contact with the current collector, wherein the electrode has a raised pattern as well as a method of making and using the same and also for electrochemical cells incorporating the same.

### FIELD

This disclosure relates to electrodes for electrochemical cells and electrochemical cells made with them.

### BACKGROUND

Rechargeable lithium ion batteries are included in a variety of electronic devices. Most commercially available lithium ion batteries have negative electrodes that include materials such as graphite that are capable of incorporating lithium through an intercalation mechanism during charging. Such intercalation-type electrodes generally exhibit good cycle life and coulombic efficiency. However, the amount of lithium that can be incorporated per unit mass of intercalation-type material is relatively low.

A second class of negative electrode materials is known that incorporate lithium through an alloying mechanism during charging. Although these alloy-type materials can often incorporate higher amounts of lithium per unit mass than intercalation-type materials, the addition of lithium to the alloy is usually accompanied with a large volume change. Some alloy-type negative electrodes exhibit relatively poor cycle life and low energy density.

The poor performance of alloy-type negative electrodes can result from the large volume changes in the negative electrode resulting from lithiation and delithiation of the alloy. This volume change can result in large internal stresses being produced when such electrodes are incorporated in a lithium ion cell. As a consequence the negative electrode can expand and contract in all directions during the normal charge/discharge process. This expansion can cause internal stresses that can produce, for instance, distortion of the current collector, tearing of the current collector, and/or crushing of the cell separator. Any of these effects can severely reduce cycle life and also adversely affect the cell safety.

### SUMMARY

In view of the foregoing, it is recognized that there is a need for an electrochemical cell design that can tolerate the internal stresses produced by the volume expansion of negative electrodes comprising alloy negative electrode materials during charging and discharging.

In one aspect, this disclosure provides an electrode for an electrochemical cell that includes a current collector, and an active material in electrical contact with the current collector, wherein the electrode has a raised pattern.

In another aspect, this disclosure provides for a method of making an electrode that includes adding an active material to a current collector and providing the current collector that includes an active material with a raised pattern.

In yet another aspect, this disclosure provides for an electrochemical cell that includes a negative electrode, a positive electrode, and a separator, wherein the negative electrode, the positive electrode, or both include a current collector, and an active material in electrical contact with the current collector, wherein at least one of the electrodes that includes an active material in electrical contact with the current collector has a raised pattern.

In this application:

the articles “a”, “an”, and “the” are used interchangeably with “at least one” to mean one or more of the elements being described;

the term “metal” refers to both metals and to metalloids such as carbon, silicon and germanium, whether in an elemental or ionic state;

the term “alloy” refers to a composition of two or more metals that have physical properties different than those of any of the metals by themselves;

the terms “lithiate” and “lithiation” refer to a process for adding lithium to an electrode material;

the terms “delithiate” and “delithiation” refer to a process for removing lithium from an electrode material;

the term “active material” refers to a material that can undergo lithiation and delithiation;

the term “inactive material” refers to a material that is incapable of undergoing lithiation and delithiation;

the terms “powders” or “powdered materials” refer to particles that can have an average maximum length in one dimension that is no greater than about 100 μm.
the terms “charge” and “charging” refer to a process for providing electrochemical energy to a cell;

the terms “discharge” and “discharging” refer to a process for removing electrochemical energy from a cell, e.g., when using the cell to perform desired work;

the phrase “positive electrode” refers to an electrode (often called a cathode) where electrochemical reduction and lithiation occurs during a discharging process; and

the phrase “negative electrode” refers to an electrode (often called an anode) where electrochemical oxidation and delithiation occurs during a discharging process;

the term “raised feature” is used to describe an embossed element in a raised pattern;

the phrase “raised pattern” refers to raised features on a sheet that can extend above or below the plane of the sheet or both. A raised pattern can be in the form of a regular array of raised features, a random arrangement of raised features, a combination of different regular or random arrangements of raised features or any arrangement of raised features on the surface and furthermore that the raised features can consist of one, two, three, or more levels of depth. In addition the phrase “raised pattern” can refer to corrugation of an electrode with or without raised features. The raised pattern can be above the plane of the electrode or below the plane of the electrode (commonly known as debossing) or both and can include convex or concave elements, or both; and

the term “z-direction” and “z-direction dimension” refer to the maximum extension of the raised pattern above or below the plane of the electrode and perpendicular to the plane of the electrode.

### BRIEF DESCRIPTION OF THE DRAWINGS

FIG. 1a illustrates an embodiment of an electrode that has a square-lattice pattern of raised dots.

FIG. 1b illustrates an embodiment of an electrode that has a triangular-lattice pattern of raised dots.

FIG. 1c illustrates an embodiment of an electrode that has pleats that are corrugated.

FIG. 1d illustrates an embodiment of an electrode that has undulating pleats in a sinusoidal shape.

FIG. 1e illustrates an embodiment of an electrode that has beveled, undulating pleats on two edges.

FIG. 2 is an exploded view of a jellyroll configuration of a lithium-ion electrochemical cell that includes an electrode with a raised pattern, in another embodiment of this disclosure.

FIGS. 3a and 3b are illustrations of embodiments of two electrochemical cells in a jellyroll configuration. FIG. 3a has one electrode with a square-lattice pattern of raised dots and the other electrode is flat. FIG. 3b has both electrodes flat.

### DETAILED DESCRIPTION

All numbers are herein assumed to be modified by the term “about”. The recitation of numerical ranges by endpoints includes all numbers subsumed within that range (e.g., 1 to 5 includes 1, 1.5, 2, 2.75, 3, 3.80, 4, and 5).

The electrodes according to this disclosure include a current collector and an active material in electrical contact with the current collector. The current collector can be any material or combination of materials known in the art. For example, typically current collectors used in lithium ion electrochemical cells include thin foils of conductive metals or alloys such as, for example, aluminum or aluminum alloys for the positive electrode and copper, stainless steel, nickel, and combinations thereof for the negative electrode. The foils can have a thickness of from about 5 to about 20 microns. Current collectors can also include polymeric films including electrically conducting coatings or films.

According to this disclosure there is at least one active material in electrical contact with the current collector. A variety of active materials can be employed. These active materials can be in the form of a powder in a composite coating or in the form of a deposited layer of active material as, for example, a thin sputtered film. Active materials for the negative electrode can be in the form of a single chemical element or an alloy. Exemplary active materials for a negative electrode can for example include one or more metals or metalloids such as carbon, silicon, silver, lithium, tin, bismuth, lead, antimony, germanium, zinc, gold, platinum, palladium, arsenic, aluminum, gallium, and indium. The active materials for a negative electrode can further include one or more inactive elements such as, molybdenum, niobium, tungsten, tantalum, iron, copper, titanium, vanadium, chromium, manganese, nickel, cobalt, zirconium, yttrium, lanthanides, actinides and alkaline earth metals. Alloys can be amorphous, can be crystalline or nanocrystalline, or can exist in more than one phase. Powders can have a maximum dimension in one direction that is no greater than 100 μm, no greater than 80 μm, no greater than 60 μm, no greater than 40 μm, no greater than 20 μm, no greater than 2 μm, or even smaller. The powdered materials can, for example, have a particle diameter (smallest dimension) that is submicron, at least 0.5 μm, at least 1 μm, at least 2 μm, at least 5 μm, or at least 10 μm or even larger. For example, suitable powders often have dimensions of 0.5 μm to 100 μm, 0.5 μm to 80 μm, 0.5 μm to 60 μm, 0.5 μm to 40 μm, 0.5 μm to 2.0 μm, 10 to 60 μm, 20 to 60 μm, 40 to 60 μm, 2 to 40 μm, 10 to 40 μm, 5 to 20 μm, or 10 to 20 μm.

When alloys exist in more than one phase, each phase originally present in the particle (i.e., before a first lithiation) can be in contact with other phases in the particle. For example, in particles based on a silicon:copper:silver alloy, a silicon phase can be in contact with both a copper silicide phase and a silver or silver alloy phase. Each phase in a particle can for example have a maximum dimension in one direction of less than about 50 nm, less than about 40 nm, less than about 30 nm, less than about 20 nm, less than about 15 nm, or even smaller.

Exemplary silicon-containing active materials include the silicon alloys wherein the active material comprises from about 50 to about 85 mole percent silicon, from about 5 to about 12 mole percent iron, from about 5 to about 12 mole percent titanium, and from about 5 to about 12 mole percent carbon. Additionally, the active material can be pure silicon. More examples of useful silicon alloys include compositions that include silicon, copper, and silver or silver alloy such as those discussed in U.S. Pat. Appl. Publ. No. 2006/0046144 (Obrovac et al.); multiphase, silicon-containing electrodes such as those discussed in U.S. Pat. Appl. Publ. No. 2005/0031957 (Christensen et al.); silicon alloys that include tin, indium and a lanthanide, actinide element or yttrium such as those described in U.S. Ser Nos. 11/387,205; 11/387,219; and 11/387,557 (all to Obrovac et al.); amorphous alloys having a high silicon content such as those discussed in U.S. Ser. No. 11/562,227 (Christensen et al.); other powdered materials used for electrodes such as those discussed in U.S. Ser. No. 11/419,564 (Krause et al.); U.S. Ser. No. 11/469,561 (Le); PCT US2006/038558 (Krause et al.); and U.S. Pat. No. 6,203,944 (Turner).

Electrodes of this disclosure can also include a composite that includes an active material, graphite and a binder. Examples of negative electrodes including graphite are disclosed in Applicant's copending application, U.S. Ser. No. 11/679,591 (Christensen et al.).

Useful negative electrodes can also be provided as a thin film of active material directly adhered to and in electrical contact with the current collector. The thin film can be applied to the current collector, for example, by means of evaporative or chemical vapor deposition, plasma deposition or sputtering. The thin film can be in the form of a pure element or an alloy. The thin film can be pure silicon. The thin film can be an alloy that includes only active elements or both active and inactive elements. Examples of useful negative thin film electrodes are described in U.S. Pat. Nos. 6,203,944, 6,255,017, 6,436,578, and 6,699,336 (all to Turner or Turner et al.) and U.S. Ser. No. 11/387,557 (Obrovac et al.).

Useful active materials for making positive electrodes of the electrochemical cells and batteries or battery packs of this disclosure include lithium. Examples of positive active materials include Li_{4/3}Ti_{5/3}O₄, LiV₃O₈, LiV₂O₅, LiCoO₂Ni_{0.8}O₂, LiNiO₂, LiFePO₄, LiMnPO₄, LiCoPO₄, LiMn₂O₄, and LiCoO₂; the positive active material compositions that include mixed metal oxides of cobalt, manganese, and nickel such as those described in U.S. Pat. Nos. 6,964,828; 7,078,128 (Lu et al.); and nanocomposite positive active materials such as those discussed in U.S. Pat. No. 6,680,145 (Obrovac et al.).

Electrodes of this disclosure can include a binder. Exemplary polymer binders include polyolefins such as those prepared from ethylene, propylene, or butylene monomers; fluorinated polyolefins such as those prepared from vinylidene fluoride monomers; perfluorinated polyolefins such as those prepared from hexafluoropropylene monomer; perfluorinated poly(alkyl vinyl ethers); perfluorinated poly(alkoxy vinyl ethers); or combinations thereof. Specific examples of polymer binders include polymers or copolymers of vinylidene fluoride, tetrafluoroethylene, and propylene; and copolymers of vinylidene fluoride and hexafluoropropylene.

In some electrodes, the binders can be crosslinked. Crosslinking can improve the mechanical properties of the binders and can improve the contact between the active material composition and any electrically conductive diluent that can be present. Other binders include polyimides such as the aromatic, aliphatic or cycloaliphatic polyimides described in U.S. Ser. No. 11/218,448 (Krause et al.).

Electrodes that include binders can include lithium polyacrylate as disclosed in co-owned application U.S. Ser. No. 11/671,601(Le). Lithium polyacrylate can be made from poly(acrylic acid) that is neutralized with lithium hydroxide. In this application, poly(acrylic acid) includes any polymer or copolymer of acrylic acid or methacrylic acid or their derivatives where at least about 50 mole %, at least about 60 mole %, at least about 70 mole %, at least about 80 mole %, or at least about 90 mole % of the copolymer is made using acrylic acid or methacrylic acid. Useful monomers that can be used to form these copolymers include, for example, alkyl esters of acrylic or methacrylic acid that have alkyl groups with 1-12 carbon atoms (branched or unbranched), acrylonitriles, acrylamides, N-alkyl acrylamides, N,N-dialkylacrylamides, hydroxyalkylacrylates, and the like. Of particular interest are polymers or copolymers of acrylic acid or methacrylic acid that are water soluble—especially after neutralization or partial neutralization. Water solubility is typically a function of the molecular weight of the polymer or copolymer and/or the composition. Poly(acrylic acid) is very water soluble and is preferred along with copolymers that include significant mole fractions of acrylic acid. Poly(methacrylic) acid is less water soluble-particularly at larger molecular weights.

To make a positive or a negative electrode composite coating, the active powdered material, any selected additives such as binders, conductive diluents, fillers, adhesion promoters, thickening agents for coating viscosity modification such as carboxymethylcellulose (CMC) and other additives known by those skilled in the art are mixed in a suitable coating solvent such as water or N-methylpyrrolidinone (NMP) to form a coating dispersion or coating mixture. The dispersion is mixed thoroughly and then applied to a foil current collector by any appropriate dispersion coating technique such as knife coating, notched bar coating, dip coating, spray coating, electrospray coating, or gravure coating. The current collectors are typically thin foils of conductive metals such as, for example, copper, aluminum, stainless steel, or nickel foil. The slurry is coated onto the current collector foil and then allowed to dry in air followed usually by drying in a heated oven, typically at about 80° C. to about 300° C. for about an hour to remove the solvent.

This disclosure provides electrodes having a raised pattern for use in electrochemical cells. Furthermore, the disclosure provides for electrodes in lithium ion electrochemical cells. The disclosure is not limited by the arrangement of raised features in the raised pattern, the shape or profile of raised features in the raised pattern or the depth or depths of raised features, except as discussed in this disclosure and foreseeable modifications thereof.

Typical electrodes containing negative electrode active materials can have a z-direction dimension of 5 μm to 200 μm and can expand by as little as 10% or as much as 300% in volume. This expansion can occur in the direction perpendicular to the surface of the electrode, corresponding to a z-direction dimension change in the range of about 1 μm to about 100 μm. According to this disclosure, one electrode or both electrodes in an electrochemical cell can include a raised pattern. The raised pattern in the electrode has the effect of increasing the total z-direction dimension of the electrode or electrodes. During charging of a lithium ion cell the volume expansion of the negative electrode can cause the raised pattern in the embossed electrode to flatten. In this mode of the disclosure, the raised pattern on one or both electrodes can provide volume to accommodate the volume expansion of the negative electrode. The raised pattern can increase the total electrode z-direction dimension by an amount about equal to the increase in z-direction dimension causes by the expansion of the negative electrode during lithiation. For instance, the increased z-dimension direction of the electrode after embossing with a raised pattern can be less than about 1 mm, less than about 0.5 mm, less than about 0.1 mm, less than about 50 μm, less than about 25 μm, less than about 10 μm or even less.

The disclosure is not limited to the shape or aspect ratio of raised features in the raised pattern. The raised features can be rounded, so as not to affect the adhesion of the electrode coating to the current collector during the embossing process and also to give a more even current distribution during cycling. Alternatively, raised features can be in the shape of a circle, square, oval, another regular shape or an irregular shape. The electrodes can also be corrugated. By corrugated it is meant that the electrodes can be shaped into folds or substantially parallel alternating ridges and grooves. It is also contemplated that the ridges and groves can be rounded. Additionally it is possible that raised features can undulate in a substantially sinusoidal fashion so that the electrode has a substantially sinusoidal cross-section when viewed edge-on. It is also possible to have small raised features on corrugated electrodes.

The disclosure is also not limited by the profile of raised features in the raised pattern. The profile of raised features in the raised pattern can include any known shape and can, for example, include profiles that are rounded or in the shape of spheres, ovals, ellipsoids, paraboloids, and the like. The profile of raised features can have rounded edges, beveled edges, multilevel edges or irregular edges. The profile can also be sculpted to any three dimensional pattern, regular or not. There also can be multi-level patterns produced by any known means including making embossing molds with more than one raised feature or by multiple passes of the electrode through different embossing molds.

The disclosure is also not limited by the arrangement of raised features in a raised pattern. In one embodiment of the disclosure raised features can be more or less evenly distributed, in a pattern or randomly, throughout the electrode coating, so that the accommodation of the negative electrode volume expansion is evenly distributed. Suitable arrangements of raised features in a raised pattern include a square lattice arrangement, a triangular lattice arrangement, or a random arrangement. The spacing between raised features can furthermore allow for ease of winding of the electrode and the even accommodation of the negative electrode volume expansion during charging. Suitable spacings between raised features can be less than about 2 cm, less than about 1 cm, less than about 5 mm, less than about 2 mm, less than about 0.5 mm, less than about 0.1 mm or even 0 mm (for continuous raised features such as, for example, an undulating or sinusoidal feature).

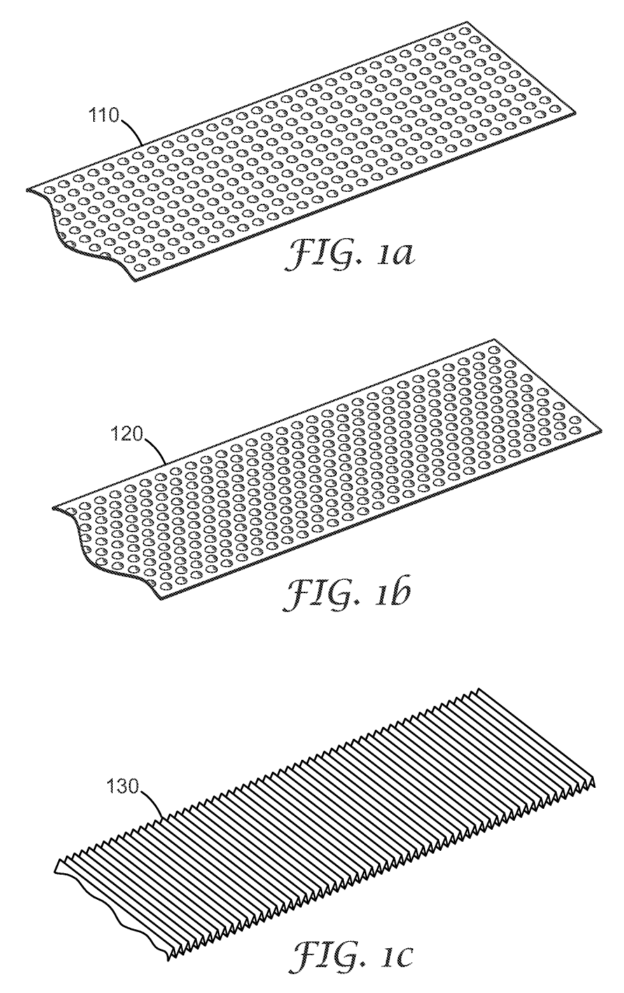

Some exemplary raised patterns are shown in FIGS. 1a-1e. FIG. 1a illustrates an embodiment in which an electrode 110 has been provided with an embossed square-lattice pattern of raised dots. The dots protrude through the plane of the foil so that on one side of the electrode the dots are raised convex surfaces and on the other side of the electrode the dots are recessed concave surfaces. FIG. 1b illustrates an embodiment in which the electrode 120 has an embossed triangular-lattice pattern of raised dots. FIG. 1c illustrates an embodiment in which electrode 130 is corrugated and has pleats or folds that are substantially v-shaped. FIG. 1d is an illustration of an embodiment in which electrode 140 has corrugated and undulating pleats that are in a substantially sinusoidal shape. FIG. 1e is an illustration of an embodiment in which electrode 150 has beveled and undulating pleats on two edges. Electrode 150 has a flat region 152 in the center of the electrode and has beveled, corrugated undulations on both edges 154.

It is contemplated that the edges of the electrode can have an embossed, raised pattern. All of the edges of the electrode can have an embossed, raised pattern, only some of the edges have an embossed, raised pattern, only one edge can have an embossed, raised pattern, only portions of the edges have an embossed, raised pattern or, in some embodiments, none of the edges can have an embossed, raised pattern. For example, in electrodes made in elongated rectangles (webs) it is sometimes advantageous to have an embossed, raised pattern along the long edge or edges of the web. This is depicted in FIG. 1e. Sometimes, in constructing an electrochemical cell the area of the anode can be larger than the area of the cathode—especially in lithium ion electrochemical cells. In this case, it can be advantageous to have an embossed, raised pattern along only those edges of the anode that extend beyond the dimensions of the cathode. All the mentioned aspects of the disclosure can be used in conjunction and in any combination. That is, either the negative electrode, the positive electrode, or both electrodes can have an embossed, raised pattern or patterns and the negative electrode can further include an embossed edge or edges. In rolled electrochemical cells, it is sometimes desirable to attach a tab 222 to the end of the electrode to enhance electrical contact. This tab can be attached to the electrode by welding or soldering. It is not desirable for the embossed area of the electrode to include the area of the electrode onto which an electrode tab 222 can be attached. The embossing pattern can interfere with forming a good weld of the tab onto the electrode.

Another aspect of the disclosure describes a method of making an electrode that includes adding an active material to a current collector, and providing the current collector with a raised pattern. Adding an active material can include applying a coating. The coating can be added by any method known to those skilled in the art. For example, the active material can be coated as a dispersion in a solvent. It can be vapor deposited. It can be laminated or electroplated.

After the active material is added to a current collector, the electrode can be calendered or uncalendered. If the electrode is calendered the calendering step can be done before providing the current collector that includes an active material with a raised pattern so that the raised pattern is not smoothed or erased during the process.

Providing the current collector that includes active material with a raised pattern can be done by passing the electrode through one or more embossing rolls. The embossing rolls can be heated or unheated. In one method the embossing rolls can comprise a roll with a positive engraving of the raised pattern and a counter roll with the negative impression of the raised pattern. In another embodiment, one roll can be engraved with an image of the raised pattern and the counter roll can be covered with a smooth rubberized or otherwise elastomeric surface. In yet another embodiment, providing the current collector that includes an active material with a raised pattern can be accomplished by pressing the electrode between plates using, for example, a hydraulic press. For instance, the electrode can be pressed between a matching set of plates with a positive and negative engraving of the raised pattern or, alternatively, one plate can be engraved with an image of the raised pattern and the other plate furnished with a rubberized or otherwise elastomeric surface.

In another embodiment providing the current collector that includes an active material with a raised pattern can be accomplished by passing a stack comprising an elastomeric sheet, the electrode and a sheet perforated or otherwise engraved with the negative image of the raised pattern through a set of rollers. This can be done in one step or multiple steps.

The pressures used to provide a raised pattern can be as small as about 500 kPa, as small as about 200 kPa, as small as about 100 kPa, as small as about 50 kPa or even smaller or higher than about 500 kPa, higher than about 1000 kPa or even higher. The temperature during the process are also not limited and can be lower than about 20° C., lower than about 15° C. or even lower or higher than about 20° C., higher than about 30° C., higher than about 60° C., higher than about 100° C., higher than about 150° C. or even higher.

Electrodes that include a composite active material can be calendered prior to providing the current collector that includes an active material with a raised pattern. Calendering is accomplished by passing the electrode through two or more rollers under pressure. Optionally, one or more of the rollers can be heated or cooled. The rollers can exert pressures from about 100 MPa, from about 500 MPa, from about 750 MPa, or from about 1000 MPa or even higher or to about 2000 MPa, to about 1500 MPa, to about 1000 MPa, to about 750 MPa or even lower.

An additional aspect of this disclosure provides for an electrochemical cell that includes a negative electrode, a positive electrode and a separator, wherein the negative electrode, the positive electrode, or both include a current collector and an active material in electrical contact with the current collector, wherein at least one of the electrodes that comprises an active material in electrical contact with the current collector has a raised pattern. The electrochemical cells of this disclosure can include a separator. They also can include an electrolyte.

Electrochemical cells of this disclosure are made by taking at least one each of a positive electrode and a negative electrode, wherein at least one of the electrodes comprises an active material in electrical contact with the current collector and has a raised pattern as described above, and placing them in an electrolyte. Typically, a microporous separator, such as CELGARD 2400 microporous material, available from Hoechst Celanese, Corp., Charlotte, N.C., is used to prevent an electrical short circuit from contact of the negative electrode directly with the positive electrode.

A variety of electrolytes can be employed in the disclosed lithium-ion cell. Representative electrolytes include one or more lithium salts and a charge-carrying medium in the form of a solid, liquid or gel. Exemplary lithium salts include LiPF₆, LiBF₄, LiClO₄, lithium bis(oxalato)borate, LiN(CF₃SO₂)₂, LiN(C₂F₅SO₂)₂, LiAsF₆, LiC(CF₃SO₂)₃, and combinations thereof. Exemplary charge-carrying media are stable without freezing or boiling in the electrochemical window and temperature range within which the cell electrodes can operate, are capable of solubilizing sufficient quantities of the lithium salt so that a suitable quantity of charge can be transported from the positive electrode to the negative electrode, and perform well in the chosen lithium-ion cell. Exemplary solid charge carrying media include polymeric media such as polyethylene oxide, polytetrafluoroethylene, polyvinylidene fluoride, fluorine-containing copolymers, polyacrylonitrile, combinations thereof and other solid media that will be familiar to those skilled in the art. Exemplary liquid charge carrying media include ethylene carbonate, propylene carbonate, dimethyl carbonate, diethyl carbonate, ethyl-methyl carbonate, butylene carbonate, vinylene carbonate, fluoroethylene carbonate, fluoropropylene carbonate, γ-butylrolactone, methyl difluoroacetate, ethyl difluoroacetate, dimethoxyethane, diglyme (bis(2-methoxyethyl) ether), tetrahydrofuran, dioxolane, combinations thereof and other media that will be familiar to those skilled in the art. Exemplary charge carrying media gels include those described in U.S. Pat. Nos. 6,387,570 (Nakamura et al.), and 6,780,544 (Noh). The charge carrying media solubilizing power can be improved through addition of a suitable cosolvent. Exemplary cosolvents include aromatic materials compatible with Li-ion cells containing the chosen electrolyte. Representative cosolvents include toluene, sulfolane, dimethoxyethane, combinations thereof and other cosolvents that will be familiar to those skilled in the art. The electrolyte can include other additives that will be familiar to those skilled in the art. For example, the electrolyte can include a redox chemical shuttle such as those described in U.S. Pat. Nos. 5,709,968 (Shimizu), 5,763,119 (Adachi); 5,536,599 (Alamgir et al.); 5,858,573 (Abraham et al.); 5,882,812 (Visco et al.); 6,004,698 (Richardson et al.); 6,045,952 (Kerr et al.); and 6,387,571 (Lain et al.); and in U.S. Pat. Appl. Publ. Nos. 2005/0221168; 2005/0221196; 2006/0263696; and 2006/0263697 (all to Dahn et al.).

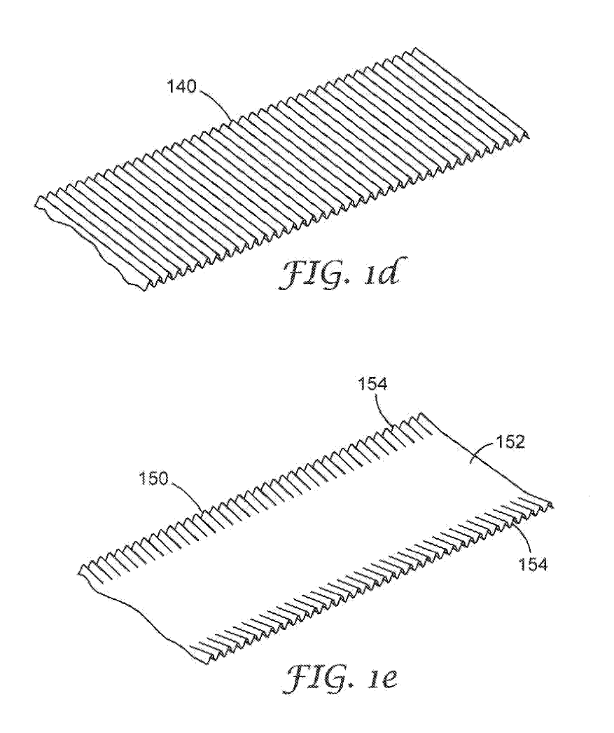

Electrochemical cells can be constructed in several geometries. Electrodes are usually employed in cells as rectangular or circular sheets. It is typical to make a stack that includes a negative electrode sheet and a positive electrode sheet with a separator sandwiched between the negative electrode and the positive electrode to form a layered structure. In coin cells, such as 2325 coin cells, the components of the layered structured can be cut into rounded disks so that they form a substantially vertical stack that can then be inserted into the body of a coin cell. It is also possible to form substantially vertical stacks that include a negative electrode, a separator, and a positive electrode that are in various geometric shapes such as, but not limited to, squares, rectangles, triangles, polygons of regular shape or polygons of any irregular shape. The substantially vertical stack can also be rectangular with the two dimensions being considerably different. For example FIGS. 1a-1e display negative electrodes of this disclosure that are in the shape of an elongated rectangle. One of these electrodes can be combined with a similarly shaped positive electrode and separator (sandwiched in between) to form a vertical stack that has a short dimension and a long dimension. In some electrochemical cell designs the elongated vertical stack described above can be rolled tightly into what is known as a “jellyroll”. FIG. 2 is an exemplary illustration of a jellyroll configuration of lithium-ion electrochemical cell component 200. The jellyroll has four layers wound around a core 240. The innermost layer, in this example, is a coated positive electrode 210 that is not embossed or corrugated. Adjacent to this layer is a separator layer 230. Next is a coated, embossed negative electrode 220 that has a tab 222 welded to its short edge. Finally another separator layer 230 is the outermost layer. The cathode layer 210 has a tab (not visible in the figure) on its innermost edge that can be electrically attached to the core 240 and the edge of the electrode 210. These four layers are wound tightly around the core. The jellyroll can then be placed into a container such as a can or pouch which can then be filled with electrolyte to form a cylindrical electrochemical cell. The jellyroll can also be flattened and placed in a container to form a prismatic cell.

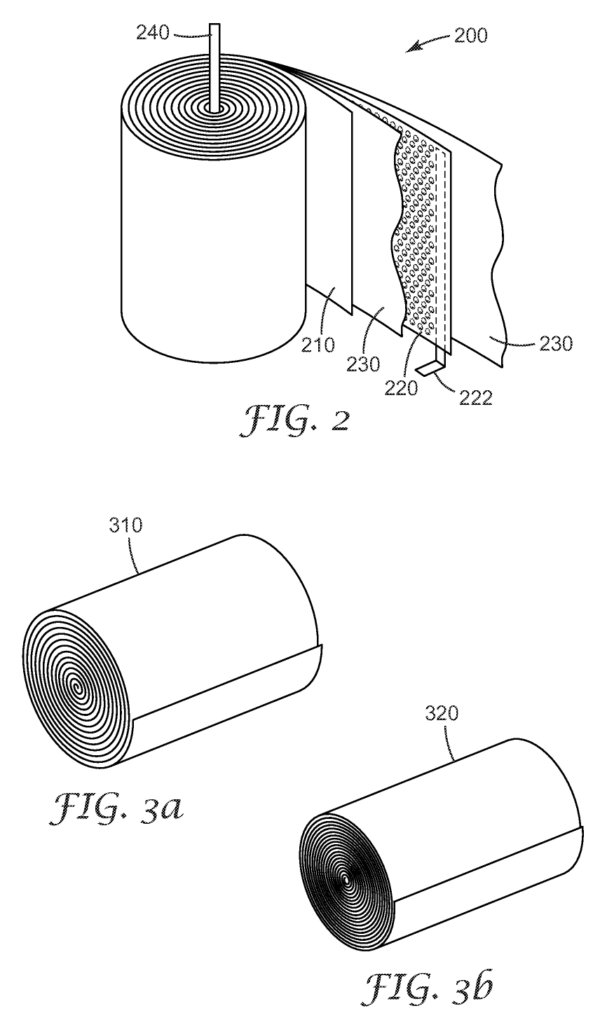

Two embodiments of jellyrolls are illustrated by FIGS. 3a and 3b. FIG. 3a is an illustration of a jellyroll 310 that was made by the same process used to make jellyroll 200 as described in FIG. 2 except that in jellyroll 310 the embossed pattern was a triangular-lattice pattern of raised dots. The anode was embossed and the cathode was flat. FIG. 3b is a jellyroll 320 made with layers having the same components and dimensions as in FIG. 3a except that in FIG. 3b both electrodes were flat. These illustrations exemplify a jellyroll with an embossed electrode taking up more volume than one lacking any embossed electrodes. The jellyroll in FIG. 3a provides space in between the embossed patterns for expansion and contraction.

It is also contemplated that the vertical stack can include multiple layers. For example, it is possible to take a negative electrode, separator, and positive electrode vertical stack and place it upon another vertical stack by placing an additional separator between the outside electrodes so that they do not make electrical contact with one another. Thus, multiple vertical stacks can be made in this manner.

The disclosed cells can be used in a variety of devices, including portable computers, tablet displays, personal digital assistants, mobile telephones, motorized devices (e.g., appliances and vehicles), instruments, illumination devices (e.g., flashlights) and heating devices. One or more electrochemical cells of this invention can be combined to provide a battery pack. Further details regarding the construction and use of rechargeable lithium-ion cells and battery packs will be familiar to those skilled in the art.

The disclosure is further illustrated in the following illustrative examples, in which all percentages are by weight percent unless otherwise indicated.

### EXAMPLES

### Preparatory Example 1—Alloy Powder

An alloy composition, Si_{74.8}Fe_{12.6}Ti_{12.6}, was prepared by melting silicon lumps (123.31 grams)(Alfa Aesar/99.999%, Ward Hill, Miss.), iron pieces (41.29 g.) (Alfa Aesar/99.97%) and titanium sponge (35.40 g.) (Alfa Aesar/99.7%) in an ARC furnace. The alloy ingot was broken and milled to produce an alloy powder with particles that had a long dimension of approximately 150 micrometers.

An alloy, Si_{66.5}Fe_{11.2}Ti_{11.2}C_{11.2}, was made from Si_{74.8}Fe_{12.6}Ti_{12.6} alloy powder (2.872 g.) and graphite (0.128 g.) (TIMREX SFG44, TimCal Ltd, Bodio, Switzerland) by reactive ball milling in a Spex mill (Spex Certiprep Group, Metuchen, N.J.) with sixteen tungsten carbide balls (3.2 mm diameter) for one hour in an argon atmosphere.

### Example 1

A negative electrode with a composition of 64.02% by weight of alloy powder, Si_{66.5}Fe_{11.2}Ti_{11.2}C_{11.2}, (average particle size 1 μm, density=3.65 g/cm³), 32.98% by weight. TIMREX SLP30 graphite powder (density=2.26 g/cm³, dOO₂=0.3354-0.3356 nanometers, TimCal Ltd.), 2.5% by weight lithium polyacrylate and 0.5% carboxymethyl cellulose was prepared as follows.

2.3 kg of deionized water, 93.23 g of poly(acrylic acid) (450 MW, Aldrich) and 31.08 g of LiOH were mixed in a Ross planetary mixer (Charles Ross and Son Company, New York) for 1 hr. A dry powder mixture of 3.00 kg alloy powder, 1.545 kg SLP-30 graphite and 23.67 g of CMC (cellulose Gum type 7H3SF, Hercules, Wilmington Del.) was slowly added to this solution. After addition, the dispersion was mixed for 1.5 hr. The resulting slurry was coated onto 10 μm copper foil on a Hirano coater using knife-over-roll, at a speed of 30.5 cm/min. The coating was dried under a flow of nitrogen in a three zone oven kept at about 30° C. Sequentially, both sides of the foil were coated.

The dried coating was pressed in a calender roll under about 1000 MPa pressure after which it had a thickness of 70 μm. The electrode was then slit into pieces of 58 mm wide by 780 mm long. An area of the electrode coating was removed from both sides of one end of the electrode with a wet cloth to expose 1.0 cm of the copper foil current collector. This was done to allow a tab to be welded onto the electrode in a later step. The electrode was then placed on a 12.7 cm by 122 cm of 16 gauge steel sheet perforated with round holes in a triangular lattice pattern with a hole diameter of 0.159 cm and the distance between the hole centers being 0.277 cm. A 0.70 mm thick sheet of rubber was then placed over the electrode such as to cover the entire electrode excepting the area of the electrode from which the coating had been removed for the tab. This assembly was then passed through a pair of steel rollers, the gap between the rollers being adjusted such that after passing through the rollers the electrode was provided with a raised dot pattern and the embossed electrode thickness was 110 μm.

A negative electrode, made as described above, was rolled up into a jellyroll as shown in FIG. 2, with alternating layers of separators and a foil positive electrode with no embossed pattern. The resulting roll, FIG. 3a was significantly larger in diameter than a control jellyroll made with two foil electrodes of the same dimensions (thickness and width) with no embossed patterns on either electrode. The control is shown in FIG. 3b.

Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows. All references referred to in this application are incorporated herein by reference.

What is claimed is:

1. An electrode for an electrochemical cell comprising:
a current collector, and
an active material in electrical contact with the current collector,
wherein the electrode has a raised pattern.

2. The electrode of claim 1 wherein the current collector comprises a foil.

3. The electrode of claim 2 wherein the foil has a thickness of from about 5 microns to about 20 microns.

4. The electrode of claim 1 wherein the current collector is selected from aluminum, aluminum alloys, copper, stainless steel, nickel and combinations thereof.

5. The electrode of claim 1 wherein the electrode comprises a negative electrode.

6. The electrode of claim 1 wherein the active material comprises an alloy powder.

7. The electrode of claim 6 wherein the powder comprises graphite.

8. The electrode of claim 1 wherein the electrode comprises a positive electrode.

9. The electrode of claim 1 wherein the active material is provided as a thin film.

10. The electrode of claim 1 wherein the raised pattern comprises a corrugation or raised features or both.

11. The electrode of claim 1 comprising a raised pattern on at least one edge of the electrode.

12. The electrode of claim 1 wherein the raised pattern comprises concave and convex raised features.

13. The electrode of claim 1 wherein the pattern comprises a substantially sinusoidal cross-section.

14. The electrode of claim 1 wherein the pattern comprises a square-lattice or a triangular lattice.

15. The pattern of claim 14 further comprising raised dots.

16. A method of making an electrode comprising:
adding an active material to a current collector; and
providing the current collector that includes an active material with a raised pattern.

17. The method of claim 16 wherein adding an active material comprises applying a coating.

18. The method of claim 17 further comprising drying the coating.

19. The method of claim 16 wherein adding an active material comprises applying a thin film of material.

20. The method of claim 16 wherein providing the current collector with a raised pattern comprises passing the electrode through embossing rollers.

21. The method of claim 16 wherein providing the current collector with a raised pattern is performed at pressures from about 10 kPa to about 250 kPa.

22. The method of claim 16 further comprising calendering the current collector that includes an active material.

23. The method of claim 22 wherein calendering is done before embossing.

24. The method of claim 22 wherein calendering comprises passing the current collector that includes an active material between rollers at a pressure of from about 250 MPa to about 1500 MPa.

25. An electrochemical cell comprising:
a negative electrode,
a positive electrode, and
a separator,
wherein the negative electrode, the positive electrode, or both comprise:
a current collector, and an active material in electrical contact with the current collector,
wherein at least one of the electrodes that comprises an active material in electrical contact with the current collector has a raised pattern.

26. A battery pack comprising at least one cell according to claim 25.
